(19) United States
(12) Patent Application Publication
(10) Pub. No.: US 2011/0239438 A1
(43) Pub. Date: Oct. 6, 2011

(54) ALIGNING METHOD AND ALIGNING APPARATUS

(75) Inventor: Hirokuni OGAWA, Sakura-shi (JP)

(73) Assignee: FUJIKURA LTD., Tokyo (JP)

(21) Appl. No.: 13/074,314

(22) Filed: Mar. 29, 2011

(30) Foreign Application Priority Data
Mar. 31, 2010 (JP) 2010-084166

(51) Int. Cl. G02B 6/26; B23Q 3/00

(52) U.S. Cl. 29/464; 385/52

(57) ABSTRACT

The present invention provides a method for adjusting a relative location of an optical fiber having a coating and a semiconductor laser for emitting multimode laser toward the optical fiber, the method including: sub-aligning steps in each of which the relative location of the optical fiber and the semiconductor laser is adjusted based on an emission amount of fiber emitting light; and a determining step between each two of the sub-aligning steps, in which determining step an emission amount of the multimode to be emitted in a latter one of the each two of the sub-aligning steps is determined based on an emission amount of multimode laser having been emitted in a former one of the each two of the aligning steps, so that no coating of the optical fiber will be damaged during the latter one of the each two of the sub-aligning steps.

This Nonprovisional application claims priority under 35 U.S.C. §119(a) on Patent Application No. 2010-084166 filed in Japan on Mar. 31, 2010, the entire contents of which are hereby incorporated by reference.

### TECHNICAL FIELD

The present invention relates to an aligning method in which a relative location of a semiconductor laser and an optical fiber for receiving light emitted from the semiconductor laser is adjusted. Particularly, the present invention relates to the aligning method in which a semiconductor laser for emitting multimode laser is employed.

### BACKGROUND ART

In manufacturing of an LD module including a semiconductor laser and an optical fiber for receiving light emitted from the semiconductor laser, it is very important to adjust a relative location of the semiconductor laser and the optical fiber relatively (i.e., to carry out aligning to the LD module) so that it is possible to obtain a maximum light coupling efficiency. This is because such arrangement can reduce a coupling loss occurring between the semiconductor laser and the optical fiber and prevent a coating of the optical fiber from being damaged. Patent Literature 1, for example, discloses a technique for carrying out aligning to the LD module. According to the technique disclosed in Patent Literature 1, at first, the aligning is carried out while driving a semiconductor laser at a small output. Then, it is determined whether a desired coupling efficiency is obtained or not, while driving the semiconductor laser at a large output.

An LD module, which includes a high-output semiconductor laser for emitting multimode laser, has also been increasingly used in many scenes.

### CITATION LIST

### Patent Literature 1

Japanese Patent Application Publication, Tokukai, No. 2005-182014 A (Publication Date: Jul. 7, 2005)

### SUMMARY OF INVENTION

### Technical Problem

However, such a technique for carrying out alignment to an LD module including a high-output semiconductor laser for emitting multimode laser has a problem described as follows.

In a case of multimode laser, spatial mode distribution varies in response to a change in an amount of an electric current supplied to the semiconductor laser. That is, there is a tendency that the greater the current supplied to the semiconductor laser is (i.e., the greater an output at which the semiconductor laser is driven), the higher an order of modes of the multimode laser becomes so that a spreading angle is increased. Further, in many cases, in a case where the order of the modes of the multimode laser is higher, there is a shift in that relative location of the optical fiber 2 and the semiconductor laser 1 at which it is possible to obtain a maximum coupling efficiency or a maximum fiber output (this relative location of the optical fiber 2 and the semiconductor laser 1 is sometimes hereinafter referred to as an optimum location). Thus, there is a chance that one optimum location, which is determined at time when the semiconductor laser is driven at a small output, is shifted from another optimum location, which is determined at time when the semiconductor laser is driven at a greater output. Therefore, it is preferable to carry out aligning while driving the semiconductor laser 1 at a large output that is as similar to an output for use in actual scene as possible.

However, in a case where the aligning is carried out at time during which the semiconductor laser is driven at the large output, there is a risk that a problem as described follows occurs to a scanning process in which the optimum position of the optical fiber is detected. For example, in the scanning process, in a case where the optical fiber is metalized to be coated by a metal coating (coating agent) so that it is possible to fixate the optical fiber by using a solder, light leaked to a clad layer of the optical fiber may be absorbed by the metal coating of the optical fiber so that the metal coating of the optical fiber generates heat and is thereby broken as a result of the heat generation. Furthermore, there may be also a case that light (such as reflected light component) not coupled to the optical fiber is incident on a housing of an optical module, a jig, or the like so that the housing of the optical module, the jig, or the like generates heat and thereby damages an apparatus as a result of the heat generation.

It is therefore very useful to develop an aligning technique in which it is possible to drive the semiconductor laser by supplying thereto a greater output without causing any damage of the metal coating of the optical fiber.

The technique of the patent literature 1 is arranged so that, at first, an output of a small level is supplied to the semiconductor laser so that the optical fiber is positioned with respect to the semiconductor laser which is emitting a laser beam of a corresponding level to the small level of the output, and then, an output of an abruptly increased level is supplied to the semiconductor laser. Note, however, that the technique of the patent literature 1 has a drawback that, in a case where a semiconductor laser for emitting multimode laser is employed, a metalized part of the optical fiber or the like may be damaged depending on mode distribution of multimode laser emitted by supplying the output of the abruptly increased level to the semiconductor laser.

As is obvious from the above, there has been conventionally developed no technique in which it is possible to position the optical fiber with respect to the semiconductor laser driven by applying a large output, without causing any damage of a metalizing agent or the like of the optical fiber. The present invention is made in view of the problem, and an object of the present invention is to provide a technique in which it is possible to position an optical fiber with respect to a semiconductor laser driven by applying a large output, without causing any damage of a metalizing agent or the like of the optical fiber.

### Solution to Problem

An aligning method of the present invention is an aligning method for adjusting a relative location of an optical fiber having a coating and a semiconductor laser for emitting multimode laser light toward the optical fiber, the aligning method, including: a plurality of sub-aligning steps, in each of which (a) fiber emitting light emitted from the optical fiber is measured in light amount, while causing the semiconductor laser to emit the multimode laser having a corresponding given light amount and while causing the optical fiber to move with respect to the semiconductor laser, and then (b) the relative location of the optical fiber and the semiconductor laser is adjusted so as to be located at an optimum location where the fiber emitting light has a maximum light amount; and a determining step between each two of the plurality of sub-aligning steps, in which determining step a second given light amount to be employed in a second one of corresponding two of the plurality of sub-aligning steps being determined so as to be greater than a first given light amount having been employed in a first one of the corresponding two of the plurality of sub-aligning steps, which first one of the corresponding two of the plurality of sub-aligning steps is carried out prior to the determining steps, whereas which second one of the corresponding two of the plurality of the sub-aligning steps is carried out after the determining step, in the determining step, the second given light amount to be employed in the second one of the corresponding two of the plurality of sub-aligning steps being determined based on a measured result having been obtained in the first one of the corresponding two of the plurality of sub-aligning steps, so that no coating of the optical fiber is damaged during the second one of the corresponding two of the plurality of sub-aligning steps.

The aligning method includes the determining step between each two of the plurality of sub-aligning steps, in which determining step the second given light amount to be employed in the second one of corresponding two of the plurality of sub-aligning steps is determined so as to be greater than the first given light amount having been employed in the first one of the corresponding two of the plurality of sub-aligning steps. According to the determining step, the second given light amount is determined based on the measured result having been obtained in the first one of the corresponding two of the plurality of sub-aligning steps, so that no coating, such as metalization part, of the optical fiber is damaged during the second one of the corresponding two of the plurality of sub-aligning steps.

The measured result having been obtained in the first one of the corresponding two of the plurality of sub-aligning steps indicates a relationship between (i) the relative location of the optical fiber and the semiconductor laser and (ii) an amount of light emitted from the semiconductor laser and coupled to the optical fiber (fiber emitting light), which relationship has been obtained when the semiconductor laser has emitted the multimode laser having the given light amount. It follows that it is possible to estimate, based on the measured result, a relationship between (i) the relative location of the optical fiber and the semiconductor laser and (ii) an amount of light emitted from the semiconductor laser and not coupled to the optical fiber (leaked light). This makes it possible to suitably determine an emission amount of the semiconductor laser to be employed in the second one of the corresponding two of the plurality of sub-aligning steps so that no coating, such as the metalization part, of the optical fiber will be damaged during the second one of the corresponding two of the plurality of sub-aligning steps.

This makes the aligning method of the present invention advantageous over the invention of the patent literature 1 in which the emission amount of the semiconductor laser is increased within the predetermined range. Specifically, according to the aligning method of the present invention, it is possible to vary an amount of increase in the emission amount of the semiconductor laser, depending on a situation. It is therefore possible in a second one of each two of the plurality of sub-aligning steps to prevent an amount of leaked light from being increased due to (i) an increase in emission amount of the semiconductor laser and (ii) a resulting change in mode distribution. This makes it possible to suitably prevent the metalization part or the like of the optical fiber from being damaged.

According to the aligning method of the present invention, in the determining step, the second given light amount in the second one of the corresponding two of the plurality of sub-aligning steps is determined based on the first given light amount in the first one of the corresponding two of the plurality of sub-aligning steps. However, the determining step is not limited to this. Instead, the determining step can be arranged so that, in the determining step, (i) the fiber emitting light emitted by the optical fiber is measured in light amount, while an emission amount of the semiconductor laser is being gradually increased from the first given light amount, (ii) a gradual increase of the emission amount of the semiconductor laser from the first given light amount is suspended, when a difference between the emission amount of the semiconductor laser and a measured amount of the fiber emitting light becomes greater than a predetermined threshold, and (iii) the second given light amount is determined based on that emission amount of the semiconductor laser which is obtained when the gradual increase of the emission amount has been suspended.

According to the aligning method, after the first one of the each two of the plurality of sub-aligning steps is finished, the emission amount of the semiconductor laser is gradually increased while monitoring amount of the leaked light. This makes it possible to determine an approximate upper limit within which it is possible to increase the emitting amount of the semiconductor laser without causing any damage of the metalization part or the like of the optical fiber. As such, ranges within which increases in emission amount of the semiconductor laser are allowed can be set for the respective plurality of sub-aligning steps, based on approximate upper limits thus determined. This makes it possible to more suitably avoid a situation that the metalization part or the like of the optical fiber is damaged during a sub-aligning step which is carried out while causing the semiconductor laser to emit light of increased amount.

An aligning apparatus of the present invention is an aligning apparatus for adjusting a relative location of an optical fiber having a coating and a semiconductor laser for emitting multimode laser toward the optical fiber, the aligning apparatus, including: an emission amount control section which controls an emission amount of the semiconductor laser; a moving section which causes the optical fiber to move with respect to the semiconductor laser; a light amount detecting section which measures a light amount of fiber emitting light emitted from the optical fiber; and a control section which controls the emission amount control section and the moving section to carry out a plurality of sub-aligning processes and to carry out a determination process between each two of the plurality of sub-aligning processes, in each of which plurality of sub-aligning processes, (a) the control section obtains, via the light amount detecting section, information indicative of the amount of the fiber emitting light emitted from the optical fiber, while causing the emission amount control section to cause the semiconductor laser to emit the multimode laser light having a corresponding given light amount and while causing the moving section to move the optical fiber with respect to the semiconductor laser, and then (b) the control section causes the relative location of the optical fiber and the semiconductor laser to be adjusted so as to be located at an optimum location where the fiber emitting light has a maximum light amount, and in which determination process, the control section determines a second given light amount to be employed in a second one of corresponding two of the plurality of sub-aligning processes, so that the second given light amount is greater than a first given light mount having been employed in a first one of the corresponding two of the plurality of sub-aligning processes, where which first one of the corresponding two of the plurality of sub-aligning processes is carried out prior to the determination process, whereas which second one of the corresponding two of the plurality of sub-aligning processes is carried out after the determination process, the control section determining the second given light amount in accordance with a result having been obtained in the first one of the corresponding two of the plurality of sub-aligning processes, so that no coating of the optical fiber is damaged during the second one of the corresponding two of the plurality of sub-aligning processes.

In the configuration, it is possible to bring about an effect similar to that of the aligning method of the present invention.

### Advantageous Effects of Invention

An aligning method of the present invention is An aligning method for adjusting a relative location of an optical fiber having a coating and a semiconductor laser for emitting multimode laser light toward the optical fiber, the aligning method, including: a plurality of sub-aligning steps, in each of which (a) fiber emitting light emitted from the optical fiber is measured in light amount, while causing the semiconductor laser to emit the multimode laser having a corresponding given light amount and while causing the optical fiber to move with respect to the semiconductor laser, and then (b) the relative location of the optical fiber and the semiconductor laser is adjusted so as to be located at an optimum location where the fiber emitting light has a maximum light amount; and a determining step between each two of the plurality of sub-aligning steps, in which determining step a second given light amount to be employed in a second one of corresponding two of the plurality of sub-aligning steps being determined so as to be greater than a first given light amount having been employed in a first one of the corresponding two of the plurality of sub-aligning steps, which first one of the corresponding two of the plurality of sub-aligning steps is carried out prior to the determining steps, whereas which second one of the corresponding two of the plurality of the sub-aligning steps is carried out after the determining step. According to the aligning method of the present invention, it is therefore possible to align the optical fiber and the semiconductor laser to each other, while driving the semiconductor laser at a large output without causing any damage of a metalization part or the like of the optical fiber.

### BRIEF DESCRIPTION OF DRAWINGS

FIG. 1

FIG. 1 is a view schematically showing a block diagram of an aligning device in accordance with embodiments (Embodiments 1 and Embodiment 2) of the present invention.

FIG. 2

FIG. 2 is a view showing, in detail, a block diagram of a main controlling section of the aligning device in accordance with one embodiment (Embodiment 1) of the present invention.

FIG. 3

(a) to (c) of FIG. 3 are graphs each showing a range over which scanning in a step of an aligning method is carried out, in accordance with the one embodiment (Embodiment 1) of the present invention.

FIG. 4

FIG. 4 is a flow chart showing a second measuring step of the aligning method in accordance with the one embodiment (Embodiment 1) of the present invention.

FIG. 5

FIG. 5 is a graph showing the range over which the scanning in the second measuring step of the aligning method is carried out, in accordance with the one embodiment (Embodiment 1) of the present invention.

FIG. 6

FIG. 6 is a graph showing a determining step of the aligning method in accordance with the one embodiment (Embodiment 1) of the present invention.

FIG. 7

FIG. 7 is a graph showing the determining step of the aligning method in accordance with the one embodiment (Embodiment 1) of the present invention.

FIG. 8

FIG. 8 is a graph showing a threshold employed in the aligning method, in accordance with the one embodiment (Embodiment 1) of the present invention.

FIG. 9

FIG. 9 is a flow chart showing a second measuring step of an aligning method in accordance with one embodiment (Embodiment 2) of the present invention.

FIG. 10

FIG. 10 is a view showing, in detail, a block diagram of a main controlling section of the aligning device in accordance with the one embodiment (Embodiment 2) of the present invention.

FIG. 11

FIG. 11 is a view showing axes along which a relative location of an optical fiber and a semiconductor laser is adjusted in the aligning method, in accordance with the embodiments (Embodiments 1 and Embodiment 2) of the present invention.

FIG. 12

FIG. 12 is a graph showing a relationship between (i) a driving current supplied to the semiconductor laser and (ii) an output supplied from the semiconductor laser, in accordance with the embodiments (Embodiments 1 and Embodiment 2) of the present invention.

### DESCRIPTION OF EMBODIMENTS

### Embodiment 1

(Aligning Device)

First, with reference to the drawings, an aligning device 10 is described in accordance with one embodiment (Embodiment 1) of the present invention. The aligning device 10 can be used so as to carry out an aligning method in which a relative location of an optical fiber 2 and a semiconductor laser 1 is adjusted.

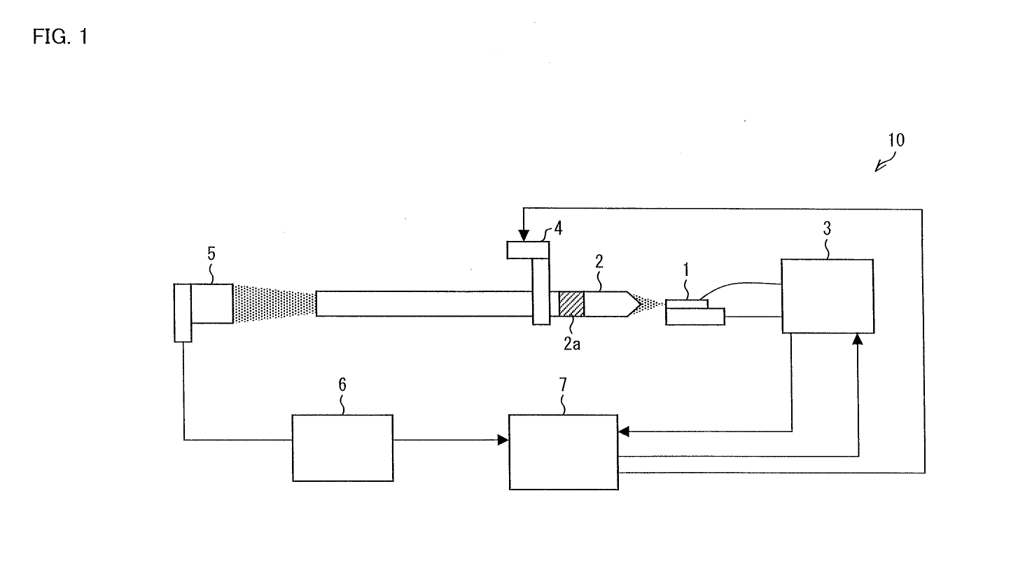

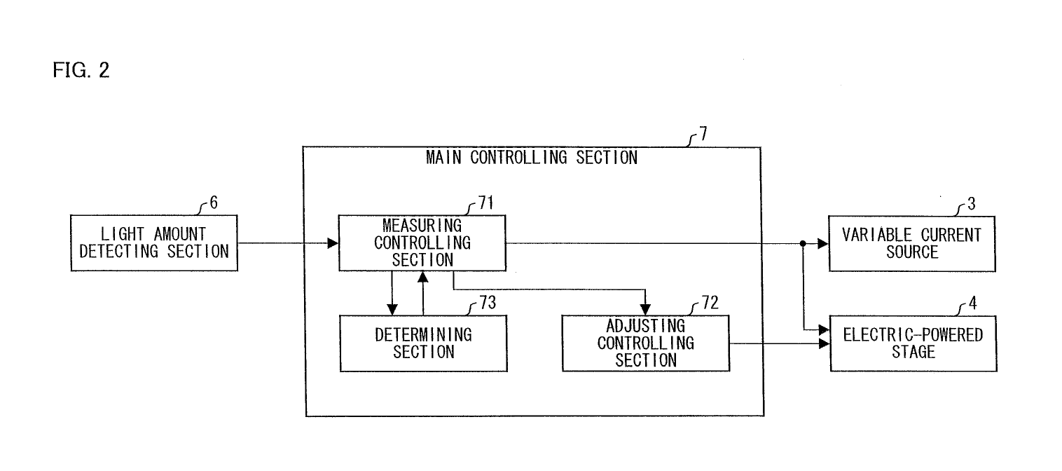

As shown in FIG. 1, the aligning device 10 includes a variable current source (emission amount controlling section) 3, an electric-powered stage (moving section) 4, a photodetector 5, a light amount detecting section 6, and a main controlling section (controlling section) 7. The semiconductor laser 1 and the optical fiber 2 are set up in the aligning device 10. As shown in FIG. 2, the main controlling section 7 includes a measurement controlling section 71, an adjustment controlling section 72, and a determining section 73.

The semiconductor laser 1 emits multimode laser toward the optical fiber 2. The multimode laser emitted from the semiconductor laser 1 enters a first end surface of the optical fiber 2 and then exits from a second end surface of the optical fiber 2, which first end surface is an end surface facing the semiconductor laser 1 whereas which second end surface is an end surface opposite to the first end surface. In the present Specification, the light which exits from the second end surface is referred to as “fiber emitting light”.

As shown in FIG. 1, an end part of the optical fiber 2 which end part faces the semiconductor laser 1 has a wedged shape. An edge line of the wedged shape extends in a direction orthogonal to a direction in which the semiconductor laser 1 is laminated. Also, the optical fiber 2 is partially coated with a metalization agent (i.e., coverture).

The variable current source 3 supplies an electric current to the semiconductor laser 1. The main controlling section 7 controls an amount of the electric current supplied from the variable current source 3 to the semiconductor laser 1.

The electric-powered stage 4 causes a change in the relative location of the optical fiber 2 and the semiconductor laser 1. According to the present embodiment, the electric-powered stage 4 causes the optical fiber 2 to move with respect to the semiconductor laser 1. The present embodiment is, however, not limited to this, provided that the electric-powered stage 4 causes at least one of the semiconductor laser 1 and the optical fiber 2 to move. Further, according to the present embodiment, the electric-powered stage 4 causes the optical fiber 2 to move along three (3) axes X, Y, and Z. The axes X, Y, and Z are later described. The main controlling section 7 controls the electric-powered stage 4 to cause the relative location of the optical fiber 2 and the semiconductor laser 1 to move along the axes X, Y, and Z.

The photodetector 5 and the light amount detecting section 6 serve as measuring means for measuring an amount of the light which has exited from the optical fiber 2. The photodetector 5 is, for example, a normal photodiode. The light amount detecting section 6 converts a signal supplied from the photodetector 5, so as to detect the amount of the light which has exited from the optical fiber 2. Then, information relating to the amount of the light thus detected is supplied, in the form of a signal, to the main controlling section 7.

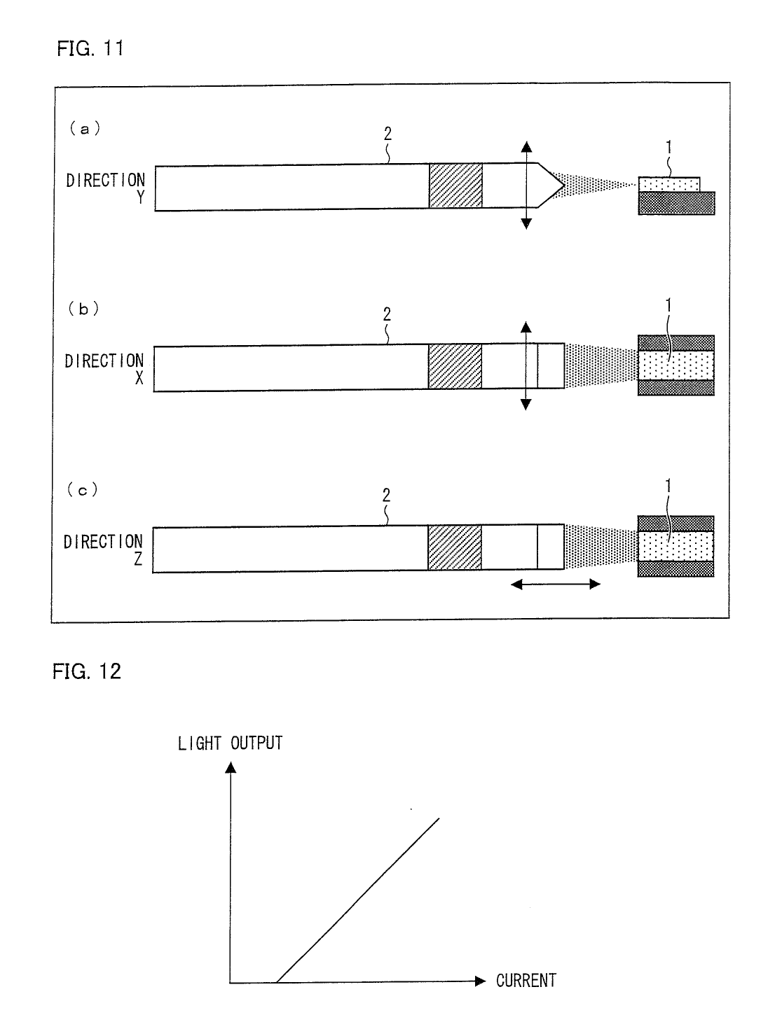

With reference to FIG. 11, the following description discusses the axes X, Y, and Z, along which the relative location of the optical fiber 2 and the semiconductor laser 1 is adjusted. (a) of FIG. 11 is a side view obtained when the semiconductor laser 1 and the optical fiber 2 are viewed from a lateral side. (b) and (c) of FIG. 11 are top views each obtained when the semiconductor laser 1 and the optical fiber 2 are viewed from above. As is indicated by an arrow in (a) of FIG. 11, a direction Y (axis Y) extends in a direction that is orthogonal to a longitudinal direction of the optical fiber 2 and is in parallel with the direction in which the semiconductor laser 1 is laminated. As is indicated by an arrow in (b) of FIG. 11, a direction X (axis X) extends in a direction which is orthogonal to the longitudinal direction of the optical fiber 2 and to the direction in which the semiconductor laser 1 is laminated. As is indicated by an arrow in (c) of FIG. 11, a direction Z (axis Z) extends in a direction same as the longitudinal direction of the optical fiber 2. Note that the electric-powered stage 4 can be arranged so as to move the optical fiber 2 in the directions X, Y, and Z and to rotate (incline) the optical fiber 2 around the axes X, Y, and Z.

The following description discusses a case in which the relative location of the optical fiber 2 and the semiconductor laser 1 is adjusted along the axis X. However, the present invention is not limited to this. Instead, the relative location of the optical fiber 2 and the semiconductor laser 1 can be adjusted along the axis Y and/or the axis Z. Note, however, that the mode distribution has a greatest change along the axis X, as a result of an occurrence of the foregoing high order modes. In view of the circumstances, the present invention is applicable to a step in which the relative location of the optical fiber 2 and the semiconductor laser 1 is adjusted along the axis X.

(Outline of Aligning Method)

The following description outlines the aligning method of the present embodiment. The aligning method of the present embodiment includes: a plurality of sub-aligning steps (preferably three (3) or more steps); and one or more determining steps, each included between corresponding adjacent two of the plurality of sub-aligning steps. In each of the one or more determining steps, it is determined how much light is to be emitted by the semiconductor laser 1 in a second one of the corresponding adjacent two of the plurality of sub-aligning steps which second one is carried out after the each of the one or more determining steps.

In each of the plurality of the sub-aligning steps, the fiber emitting light is measured in amount, while (i) the semiconductor laser 1 is being caused to emit light having a given light amount and (ii) the optical fiber 2 is being moved, along any one of the axes X, Y, and Z, with respect to the semiconductor laser 1. This allows a relationship between (i) the relative location of the optical fiber and the semiconductor laser 1 and (ii) the amount of the fiber emitting light to be obtained as a measured result. After this, the relative location of the optical fiber 2 and the semiconductor laser 1 is adjusted based on the measured result so as to become an optimum location where the fiber emitting light has a maximum light amount.

Note that the measuring of the amount of the fiber emitting light while causing the optical fiber 2 to move with respect to the semiconductor laser 1 is sometimes hereinafter referred to as scanning.

According to each of the one or more determining steps, it is determined how much light is to be emitted from the semiconductor laser 1 in the second one of the corresponding adjacent two of the plurality of the sub-aligning steps. Note that the amount of the light thus determined is always greater than an amount of light having been emitted in a first one of the corresponding adjacent two of the plurality of the sub-aligning steps which first one has been carried out prior to the each of the one or more determining steps. This allows the scanning to be carried out while gradually increasing the light amount of the semiconductor laser 1. As such, ultimately, the scanning is carried out while driving the semiconductor laser 1 at a large optical power. This allows the aligning to be carried out in accordance with a result of the scanning thus carried out.

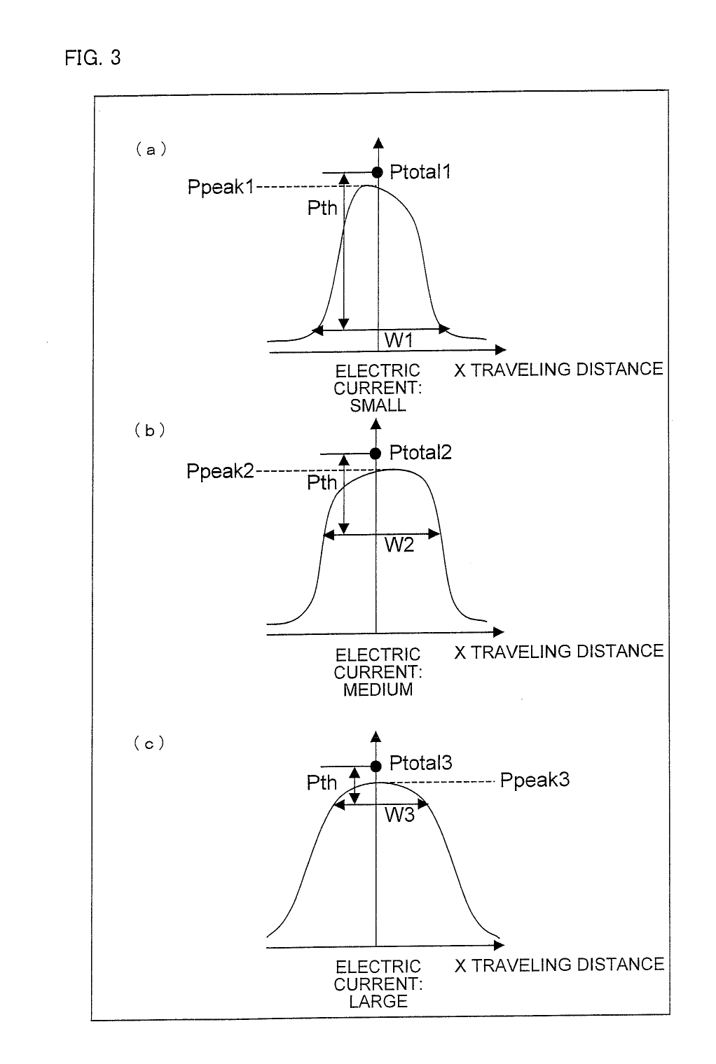

(a) through (c) of FIG. 3 are graphs showing an example of the aligning method. (a) through (c) of FIG. 3 show first through third sub-aligning steps, respectively. In (a) through (c) of FIG. 3, a horizontal axis indicates a relative location of the optical fiber 2 and the semiconductor laser 1 (in (a) through (c) of FIG. 3, the relative location of the optical fiber 2 and the semiconductor laser 1 is indicated by how long the optical fiber 2 is moved in the direction X), whereas a vertical axis indicates an amount of fiber emitting light. P_{total 1} through P_{total 3} indicate respective emitting amounts of the semiconductor laser 1. Pₜₕ indicates a predetermined threshold. P_{peak 1} through P_{peak 3} indicate respective maximum amounts of the fiber emitting light. Scale ratios in (a) through (c) of FIG. 3 are greater in this order. P_{total 1}, P_{total 2}, and P_{total 3} are greater in this order. Pₜₕ is a single value irrespective of (a) through (c) of FIG. 3. In (a) through (c) of FIG. 3, each curve line for a relative location of the optical fiber and the semiconductor laser 1 indicates a corresponding emission amount (unit: watt) of the fiber emitting light. W1 through W3 indicate respective ranges within which the emission amounts of the fiber emitting light are measured in the respective sub-aligning steps.

As shown in (a) through (c) of FIG. 3, as the process is proceeded from the first through third sub-aligning steps, the emission amount of the semiconductor laser 1 is gradually increased from P_{total 1} to P_{total 3}, and the maximum emission amount of the fiber emitting light is gradually increased from P_{peak 1} to P_{peak 3}. On the other hand, the range in which it is possible to carry out the scanning without damaging the metalized material or the like is gradually decreased from W1 to W3. Furthermore, optimum locations found for the respective first through third sub-aligning steps vary from one another. As later described, according to the aligning method of the present embodiment, (i) the scanning is successfully carried out within each of the ranges W1 through W3 and (ii) an increasing amount of the emission amount of the semiconductor laser 1 is appropriately set (i) between the first and second sub-aligning steps and (ii) between the second and third sub-aligning steps.

Note that, as described earlier, if a series of scannings are carried out in such a way that (i) first scanning is carried out while the semiconductor is driven at a small output, and then (ii) second scanning is carried out while the semiconductor laser is driven at an output abruptly increased from the small output and is thereby emitting light having an abruptly increased light amount, then there will be a risk that a metalization part or the like is damaged depending on a change in mode distribution between light emitted by driving the semiconductor laser at the small output and light emitted by driving the semiconductor laser at the greater output. In contrast, according to the aligning method of the present embodiment, in the each of the one or more determining steps, it is possible to appropriately determine how much light is to be emitted from the semiconductor laser 1 in the second one of the corresponding adjacent two of the sub-aligning steps. This makes it possible to suitably avoid a risk that the metalized part or the like of the optical fiber 2 is damaged. Furthermore, according to the aligning method of the present embodiment, three (3) or more sub-aligning steps are preferably carried out. It is therefore possible to deal with a situation in which the multimode laser emitted from the semiconductor laser 1 keeps varying in mode distribution in response to changes in the emission amount of the semiconductor laser 1. Specifically, by carrying out the sub-aligning steps at respective multiple stages, it is possible to adjust the relative location of the optical fiber and the semiconductor laser 1 in accordance with the variations in the mode distribution. This can prevent an increase in amount of leaked light. It is therefore possible to suitably avoid a risk that the metalization part or the like of the optical fiber is damaged in a case where the sub-aligning steps are carried out while causing the semiconductor laser to emit light having respective increased light amount.

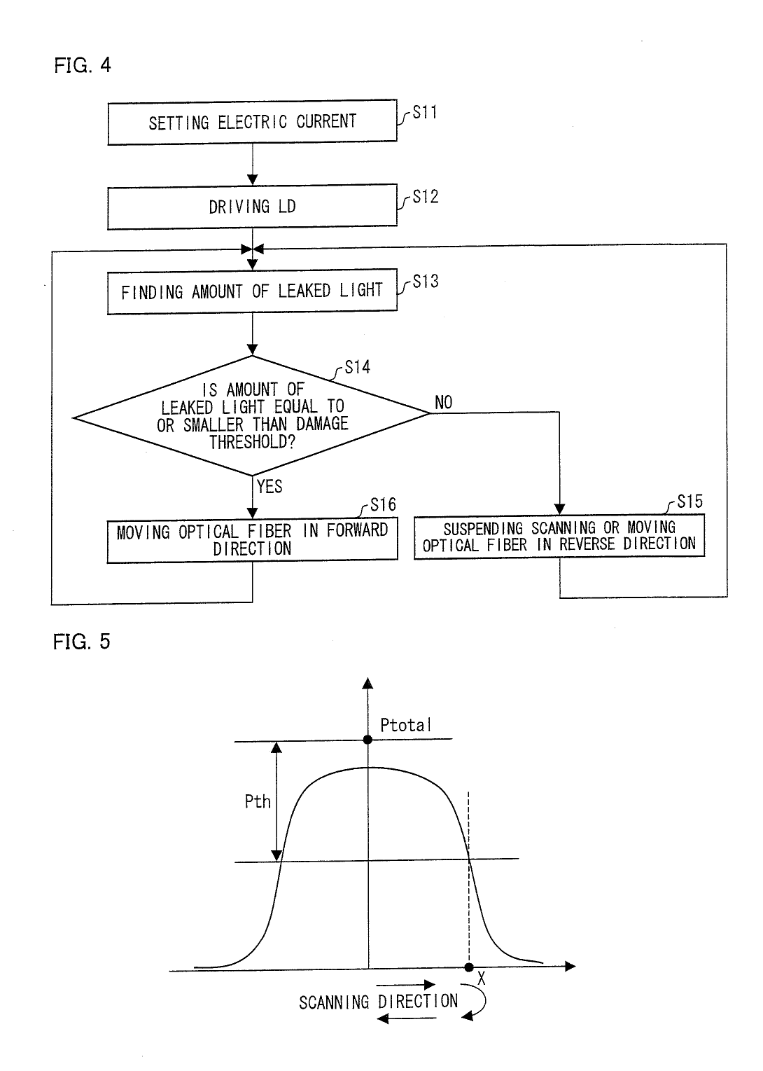

With reference to FIG. 4, the following description discusses the sub-aligning steps and the determining step in detail. FIG. 4 is a flow chart showing the aligning method in accordance with the present embodiment. In the present embodiment, the main controlling section 7 carries out the sub-aligning steps.

(Sub-Aligning Steps)

The measuring controlling section 71 of the main controlling section 7 first determines an emission amount of the semiconductor laser 1, and sets an electric current corresponding to the emission amount of the semiconductor laser 1 thus determined (step S11). In a first one of the sub-aligning steps, it is preferable that the emission amount of the semiconductor laser 1 is small. However, the emission amount of the semiconductor laser 1 is not limited to a specific amount. It can be set appropriately in accordance with characteristics of the semiconductor laser 1 and the optical fiber 2 being used in the operation. In the first one of the sub-aligning steps, the emission amount of the semiconductor laser 1 is preferably set to such a value (a value of not greater than a threshold Pₜₕ later described) that it is possible to prevent the metalization part 2a of the optical fiber 2 from being damaged by leaked light even in a case where all the light emitted from the semiconductor laser 1 ends up as the leaked light. An emission amount of the semiconductor laser 1 in each of second and subsequent ones of the sub-aligning steps is determined, in a corresponding one of the determining steps, by the determining section 73. The determining step is later described.

Note that a relationship between (i) an emission amount of a normal semiconductor laser and (ii) an electric current supplied to the normal semiconductor laser is as shown in FIG. 12. In view of such circumstances, it is preferable to measure in advance (i) electric currents supplied to the semiconductor laser 1 and (ii) emission amounts of light emitted, from the semiconductor laser, in response to the respective different electric currents. A result of the measurement should be stored, in the main controlling section 7, in the form of a table or in the form of coefficients of a given function. This allows the measuring controlling section 71 to find an electric current which the variable electric source 3 should supply to the semiconductor laser 1 so that the semiconductor laser 1 can emit light having a determined emission amount.

After the step S11, the measuring controlling section 71 of the main controlling section 7 controls the variable current source 3 to supply, to the semiconductor laser 1, an electric current determined by the controlling measuring section 71. This causes the semiconductor laser 1 to emit light having the determined emission amount (step S12).

After the step S12, scanning is carried out. The measuring controlling section 71 first obtains, from the light amount detecting section 6, information indicative of an amount of the fiber emitting light measured by the photodetector 5 and the light amount detecting section 6. The measuring controlling section 71 finds an amount of leaked light in the optical fiber 2, based on the information thus obtained (step S13). The amount of the leaked light stands for an amount of light presumed to be leaked to a clad layer of the optical fiber 2. In the present embodiment, the amount of the leaked light is found, by the measuring controlling section 71, by subtracting the amount of the fiber emitting light from the emission amount of the semiconductor laser 1 (i.e., emission amount determined by the measuring controlling section 71).

Note that, in another embodiment of the present invention, a measuring controlling section 71 can find a coupling efficiency of an optical fiber 2, instead of or in addition to the finding of an amount of leaked light. The coupling efficiency stands for a ratio of (i) light coupled to the optical fiber 2 with respect to (ii) light emitted from the semiconductor laser 1. In said another embodiment, the measuring controlling section 71 finds the coupling efficiency by dividing an amount of fiber emitting light by an emission amount of the semiconductor laser 1.

After the step S13, the measuring controlling section 71 compares the amount of the leaked light thus measured with the predetermined threshold Pₜₕ (step S14). In a case where the amount of the leaked light is not greater than the predetermined threshold Pₜₕ, the measuring controlling section 71 controls the electric-powered stage 4 to move the optical fiber 2 (step S16). This causes the relative location of the optical fiber 2 and the semiconductor laser 1 to be changed. Then, the process returns to the step S13.

On the other hand, in a case where the amount of the leaked light is greater than the threshold Pₜₕ in the step S14, the measuring controlling section 71 controls the optical fiber 2 to be moved, with respect to the semiconductor laser 1, in a reverse direction or to be stopped from being moved (step S15). This makes it possible to prevent a consecutive situation in which the amount of the leaked light is greater than the threshold Pₜₕ. Additionally, by causing the optical fiber 2 to be moved in the reverse direction, it is further possible to extend a scanning range in both of the reverse direction and a forward direction which is reverse to the reverse direction. In a case where the measuring controlling section 71 controls, in the step S15, the optical fiber 2 to be stopped from being moved, the adjusting controlling section 72 of the main controlling section 7 controls the electric-powered stage 4 to move the optical fiber 2 with respect to the semiconductor laser 1. This causes a relative location of the optical fiber 2 and the semiconductor laser 1 to be adjusted so as to become an optimum location where the fiber emitting light has a maximum light amount. After this, the first one of the sub-aligning steps is finished.

Note that, in a case where the measuring controlling section 71 has already found the coupling efficiency in the step S13, the measuring controlling section 71 carries out a process in accordance with the coupling efficiency, in the step S14, so as to obtain a result identical with that obtained by comparing the amount of the leaked light with the threshold Pₜₕ. That is, the measuring controlling section 71 compares (i) one value, which is obtained by subtracting the coupling efficiency from 1, with (ii) another value, which is obtained by dividing the threshold Pₜₕ by the emission amount of the semiconductor laser 1. This allows the measuring controlling section 71 to obtain a result identical with that obtained by comparison of the amount of the leaked light with the threshold Pₜₕ.

With reference to FIG. 5, the following description discusses in detail the scanning carried out in the measuring step. FIG. 5 is a graph showing an example of the relationship between (i) the relative location of the optical fiber 2 and the semiconductor laser 1 and (ii) the amount of the fiber emitting light. In FIG. 5, a horizontal axis indicates the relative location of the optical fiber 2 and the semiconductor laser 1, whereas a vertical axis indicates the amount of the fiber emitting light. Further, Pₜₒₜₐₗ indicates the emission amount of the semiconductor laser 1. The measuring controlling section 71 reverses a scanning direction when an amount of leaked light (which is equal to a difference between Pₜₒₜₐₗ and the amount of the fiber emitting light) becomes greater than the threshold Pₜₕ, i.e., when the relative location of the optical fiber 2 and the semiconductor laser 1 reaches X in FIG. 5 (step S15). As later described, the threshold Pₜₕ is set such that no metalization part 2a of the optical fiber 2 will be damaged as long as the amount of the leaked light is not greater than the threshold Pₜₕ. It follows that, by causing the measuring controlling section 71 to reverse the scanning direction in the way described above so that the scanning will be carried out within the range where the amount of the leaked light is not greater than the threshold Pₜₕ, it is possible to carry out a corresponding one of the plurality of the sub-aligning steps without causing the metalization part 2a of the optical fiber 2 to be damaged.

(Determining Step)

The following description discusses the one or more determining steps, each of which is carried out between corresponding adjacent two of the sub-aligning steps (i.e., each of which is carried out prior to a corresponding one of the second and subsequent ones of the sub-aligning steps). According to the present embodiment, in each of the one or more determining steps, the determining section 73 of the main controlling section 7 determines how much light is to be emitted, from the semiconductor laser 1, in a second one of the corresponding adjacent two of the sub-aligning steps.

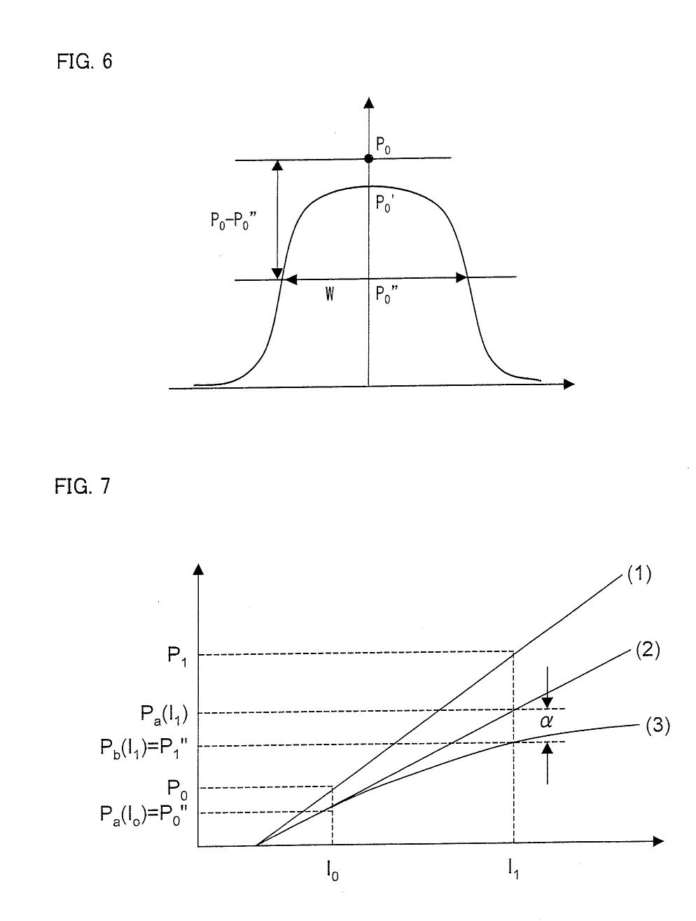

FIG. 6 is a graph showing a measuring result from the scanning carried out in a first one of the corresponding adjacent two of the sub-aligning steps. In FIG. 6, a horizontal axis indicates the relative location of the optical fiber 2 and the semiconductor laser 1, whereas a vertical axis indicates the amount of fiber emitting light. P₀ indicates an emission amount of the semiconductor laser 1 in the first one of the adjacent two of the sub-aligning steps, and P₀′ indicates a maximum amount of the fiber emitting light in the first one of the corresponding adjacent two of the sub-aligning steps. Further, P₁ indicates an emission amount of the semiconductor laser 1 in the second one of the corresponding adjacent two of the sub-aligning steps.

In the second one of each adjacent two of the sub-aligning step, scanning is carried out by changing the relative location of the optical fiber 1 to the semiconductor laser 2 from the optimum location found in the first one of each adjacent two of the sub-aligning step. Therefore, it is preferable to predict how much leaked light will be caused when the optical fiber 2 is located near the optimum location, and to determine the emission amount P₁ of the semiconductor laser 1 so that a predicted amount of the leaked light is not greater than the threshold Pₜₕ. This allows the scanning to be carried out, in the second one of each adjacent two of the sub-aligning steps, in such a way that during the scanning, the leaked light is kept smaller than the threshold so that no metalization part 2a of the optical fiber 2a or the like is damaged.

Specifically, the emission amount P₁ of the semiconductor laser 1 in the second one of each adjacent two of the sub-aligning steps is determined, by the determining section 73, so as to be greater than the emission amount P₀ of the semiconductor laser 1 in the first one of each adjacent two of the sub-aligning steps and to satisfy inequality (1):

$${P}_{1} < \frac{{P}_{th} - α}{{P}_{0} - {P}_{0}^{″}} {P}_{0} \qquad inequality ( 1 )$$

where P₀″ indicates a minimum amount of the fiber emitting light emitted from the optical fiber located within a given range W of the optimum location found by the measuring result in the first one of each adjacent two of the sub-aligning steps, and a indicates an excess loss.

The following description discusses the excess loss α with reference to FIG. 7. In FIG. 7, a horizontal axis indicates an electric current supplied to the semiconductor laser 1, whereas a vertical axis indicates a corresponding emission amount of the semiconductor laser 1. A line (1) indicates a relationship between the electric current supplied to the semiconductor laser 1 and the corresponding emission amount of the semiconductor laser 1. As indicated by the line (1), the semiconductor laser 1 emits light having a light amount P₀ in response to an electric current I₀, and emits light having a light amount P₁ in response to an electric current I₁.

A line (2) shows a relationship between (i) an electric current I supplied to the semiconductor laser 1 and (ii) a minimum amount of the fiber emitting light that is emitted, from the optical fiber 2 which is located within the given range W of the optimum location, in response to the electric current I. Note that the relationship shown by the line (2) is predicted on assumption that increasing of the emission amount of the semiconductor laser 1 by increasing the electric current I does not causes any change in a spreading angle of the light emitted from the semiconductor laser 1. In a case where the increasing of the emission amount of the semiconductor laser 1 does not cause any change in the spreading angle of the light emitted from the semiconductor laser 1, it is possible to predict an amount of the fiber emitting light by a simple proportional calculation. That is, in a case where Pₐ(I₀)=P₀″ indicates a detected minimum amount of the fiber emitting light which is emitted, from the optical fiber 2 which is located within the given range W of the optimum location, in response to the electric current I₀, Pₐ(I₁)=P₀″×P₁/P₀ can indicate a predicted minimum amount of the fiber emitting light which is predicted, by the simple proportional calculation, to be emitted, by the optical fiber 2 which is located within the given range W of the optimum location, in response to the electric current I₁.

However, in reality, the increasing of the emission amount of the semiconductor laser 1 by increasing the electric current I causes the spreading angle of the light emitted from the semiconductor laser 1 to be greater. Generally, the spreading angle meets θ₀<θ₁ when I₀<I₁, where θ₀ is a spreading angle for the current I₀, and θ₁ is a spreading angle for the current I₁. This causes a loss (an amount of light which is not coupled to the optical fiber 2) to be increased in proportion to the increase in the spreading angle. In the Specification of the present application, such a loss is referred to as an excess loss. A line (3) shows a predicted minimum amount of the fiber emitting light for the current I, which predicted minimum amount is predicted, by taking the excess loss α into account, to be emitted from the optical fiber 2 which is located within the given range W of the optimum location. As shown by the line (3), in a case of the emission amount P₁ of the semiconductor laser 1 (i.e., in a case of the electric current I₁), a predicted minimum amount P_{b}(I₁)=P₁″ of the fiber emitting light, which is predicted to be obtained within the given range W of the optimum location, is Pₐ(I₁)−α. In other words, α=Pₐ(I₁)−P_{b}(I₁).

In the second one of the adjacent two of the sub-aligning steps, a predicted amount of leaked light around the optimum location is ((P₁−P₀″)×P₁/P₀+α), by (i) taking into account even an increase (excess loss) in amount of leaked light which excess loss is caused by an increase in a spreading angle of the light emitted by the semiconductor laser 1 and (ii) using the minimum amount P₀″ of fiber emitting light around the optimum location in the first one of the adjacent two of the sub-aligning steps. It is good if the predicted amount ((P₀−P₀″)×P₁/P₀+α) is smaller than the predetermined threshold Pₜₕ. That is, by determining P₁ so that the inequality (1) is satisfied, it is possible for the amount of leaked light to become not more than the predetermined threshold Pₜₕ, around the optimum location (a range, having a width of W, whose center is the optimum location) where the scanning is started, in the scanning of the second one of the adjacent two of the sub-aligning steps. This makes it possible to successfully avoid a situation that a metal coating or the like is damaged in the second one of each adjacent two of the plurality of sub-aligning steps.

Note that the excess loss α can be found in the determining step 73 as follows. In advance, (i) spreading angles θ and (ii) light intensity distributions (far field patterns) P(θ), at which the light is emitted by the semiconductor laser 1 so as to have respective different light amounts (i.e., spreading angles θ and light intensity distributions P(θ), obtained when respective different electric currents are supplied to the semiconductor laser 1), are first measured and then (ii) a table, in which the spreading angles θ and the light intensity distributions P(θ) thus measured are associated with each other, is stored in the determining section 73.

In the determining step, the determining section 73 finds the excess loss α as follows, by using the table thus stored. The determining section 73 first obtains, with reference to the table, (i) a spreading angle θ₀ for an electric current I₀ and (ii) a spreading angle θ₁ for an electric current I₁, where (a) the electric current I₀ is assumed to be supplied to the semiconductor laser 1 during the first one of each adjacent two of the sub-aligning steps and (b) the electric current I₁ is a candidate electric current and is assumed to be supplied to the semiconductor laser 1 during the second one of each adjacent two of the sub-aligning steps. Then, the determining section 73 obtains, with reference to the table, a light intensity distribution p(θ) for the current I₁. After this, the determining section 73 finds α′ by using an equation (2):

$${α}^{′} = {\int }_{{θ}_{0}}^{{θ}_{1}} p ( θ ) d θ . \qquad equation ( 2 )$$

An excess loss α, which corresponds to a case where an electric current is increased from I₀ to I₁, can be calculated based on an equation (3):

α=P₁×α′/p equation (3),

where p is a value obtained by integrating, through an entire range of θ, a light intensity distribution p(θ) for the current value I₁.

Note that, in a case where there is no value which is greater than P₀ and satisfies inequality (1), the following measures are taken so that P₁ is determined. Specifically, the given width W is narrowed down, P₀″ is determined again based on a measured result obtained in the first one of the adjacent two sub-aligning steps, and then P₁ is determined based on P₀″. Since the given range W is decreased, a measured result for a given range, where light is less leaked, in the vicinity of the optimum location is used as a measured result obtained in the first one of the adjacent two of the sub-aligning steps which measured result is used so that P₀″ is calculated. P₀″ is therefore increased, so that the right side of inequality (1) is increased. This makes it possible to successfully determine P₁ which is greater than P₀ and satisfies the inequality (1). Note that a method for narrowing down the given range W is not limited to any specific method. For example, it is possible to narrowing down the given range W by decreasing the given range W by a given value or by multiplying the given range W by a constant value of less than 1.

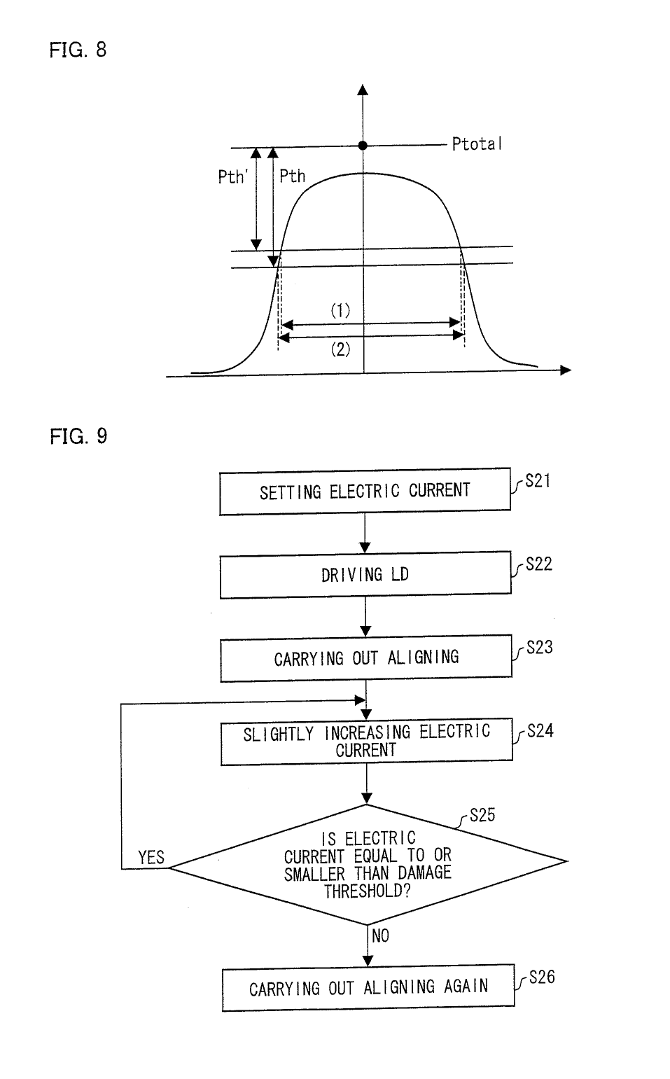

The following description discusses the foregoing predetermined threshold in detail. The predetermined threshold is set so that the metal coating 2a or the like is prevented from being damaged in a case where the amount of leaked light in the optical fiber 2 is not greater than the predetermined threshold. In a case where the metal coating 2a is damaged when a difference between an amount of light entering the optical fiber 2 and an amount of light exiting from the optical fiber 2 is greater than a certain value, it is possible to employ such a certain value as the predetermined threshold or to employ a value obtained by multiplying the certain value by k (k<1) as the predetermined threshold. In FIG. 8, Pₜₕ indicates the certain value, whereas Pₜₕ′ indicates a value obtained by multiplying the certain value by k (k<1). As shown in FIG. 8, in a case where the predetermined value Pₜₕ is employed as the threshold, scanning in each one of the sub-aligning step is carried out in a range (2). On the other hand, in a case where the threshold is set to Pₜₕ which is obtained by multiplying the given value by k (k<1), the scanning in each one of the sub-aligning step is carried out within a range of (1). As is clear from FIG. 8, the range (1) is smaller than the range (2), and it is therefore possible for the scanning range (1) to reduce a risk that the metal coating 2a or the like is damaged, as compared to the scanning range (2).

As described above, it is possible to carry out the aligning at a large optical power without damaging the metallized material, by increasing an output of the semiconductor laser 1 in a multi-stage manner while successively preventing the metal coating 2a from being damaged in the scanning which is carried out in the measuring step.

### Embodiment 2

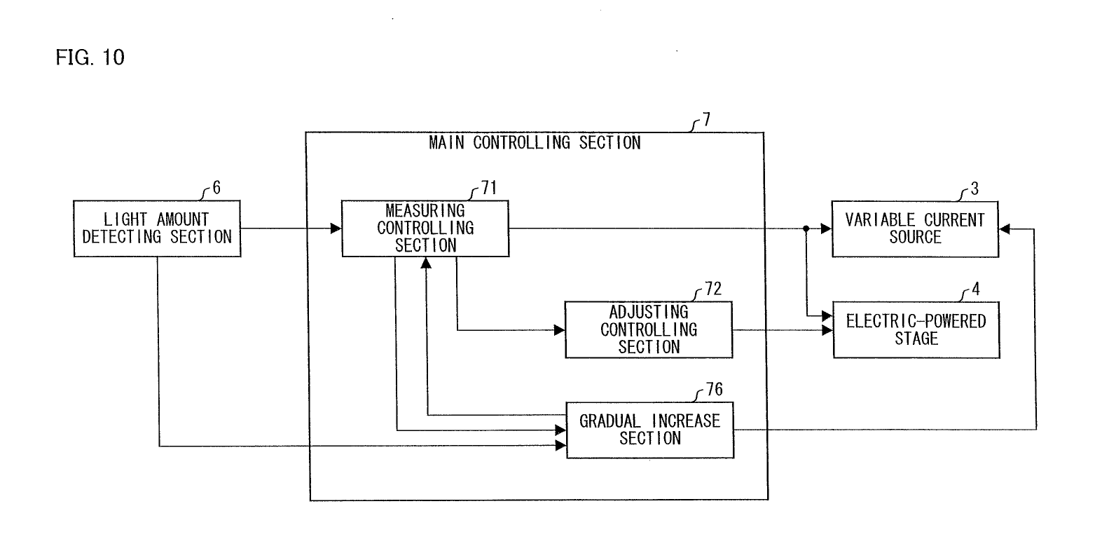

Embodiment 2 of the present invention is described below. FIG. 9 is a flow chart showing an aligning method in accordance with the present embodiment. FIG. 10 is a view schematically showing a block diagram of a main controlling section 7 of an aligning device 10 in accordance with the present embodiment. In the present embodiment, the main controlling section 7 includes a gradual increase section 76 in place of a determining section 73 (see FIG. 10) so that the gradual increase section 76 carries out a determining step. The present embodiment is different from Embodiment 1 in this regard. Note that the description of the members similar to those of the Embodiment 1 will be omitted.

FIG. 9 shows a first one (steps S21 to S23) of each adjacent two of sub-aligning steps, a determining step (step S24 and S25), and a second one (step S26) of each adjacent two of the sub-aligning steps. A measuring controlling section 71 first determines an emission amount of a semiconductor laser 1, and then determines an electric current supplied from a variable current source 3 to the semiconductor laser 1 (step S21). Then, the measuring controlling section 71 controls the variable current source 3 to supply the electric current thus determined to the semiconductor laser 1 (step S22). Then, the measuring controlling section 71 obtains, from a light amount detecting section 6, information on a light amount, while controlling an electric-powered stage 4. Then, the measuring controlling section 71 obtains, from a light amount detecting section 6, information indicative of an amount of fiber emitting light, while controlling an electric-powered stage 4. By this, scanning is carried out. Then, the adjusting controlling section 72 controls the electric-powered stage 4 to move the optical fiber 2 to an optimum location which is found by a measuring result in the scanning (step S23).

According to the present embodiment, in the determining step, the gradual increase section 76 determines the emission amount of the semiconductor laser 1. Note that, in Embodiment 1, this is carried out by the determining step 73. After the step S23, the gradual increase section 76 controls the variable current source 3 to gradually increase the emission amount of the semiconductor laser 1 (step S24). The emission amount of the semiconductor laser 1 can be gradually increased, for example, in increments of approximately 0.1 A in a case where the increment is represented by electric current.

After the step S24, the gradual increase section 76 obtains, from the light amount detecting section 6, information indicative of the amount of the fiber emitting light. Then, the gradual increase section 76 compares an amount of leaked light (which is a difference between the emission amount of the semiconductor laser 1 and the amount of the fiber emitting light) with a threshold Pₜₕ in accordance with the information thus received (step S25). In a case where the amount of the leaked light is not greater than the threshold Pₜₕ, the gradual increase section 76 returns to the step 24 so that the emission amount of the semiconductor laser 1 is further gradually increased. Note, however, that it is preferable to stop a gradual increase in the emission amount of the semiconductor laser 1 when the emission amount of the semiconductor laser 1 reaches optical power corresponding to actual usage. On the other hand, in a case where the amount of the leaked light is greater than the threshold Pₜₕ, the gradual increase section 76 stops the gradual increase in the emission amount of the semiconductor laser 1. Then, the measuring controlling section 71 carries out scanning again while the emission amount of the semiconductor laser 1, at which emission amount the gradual increase is stopped, is being kept. Then, the adjusting controlling section 72 adjusts the relative location of the optical fiber 2 to the semiconductor laser 1 in accordance with a result of the scanning (step S26).

It is therefore possible in the determining step to carry out the scanning and the adjusting of the relative location of the optical fiber 2 to the semiconductor laser 1, while causing the semiconductor laser 1 to emit light having the light amount thus increased by the gradual increase section 76. Since an output of the semiconductor laser 1 is so determined that the amount of the leaked light is not greater than the threshold Pₜₕ, it is possible to suitably prevent a metalization part 2a of the optical fiber 2 or the like from being damaged during the scanning. As described hereinabove, according to the aligning method of the present embodiment, it is possible to carry out the aligning at a large optical power without damaging the metalization part.

### SUMMARY

As discussed so far, an aligning method of the present invention is an aligning method for adjusting a relative location of an optical fiber having a coating and a semiconductor laser for emitting multimode laser light toward the optical fiber, said aligning method, including: a plurality of sub-aligning steps, in each of which (a) fiber emitting light emitted from the optical fiber is measured in light amount, while causing the semiconductor laser to emit the multimode laser having a corresponding given light amount and while causing the optical fiber to move with respect to the semiconductor laser, and then (b) the relative location of the optical fiber and the semiconductor laser is adjusted so as to be located at an optimum location where the fiber emitting light has a maximum light amount; and a determining step between each two of the plurality of sub-aligning steps, in which determining step a second given light amount to be employed in a second one of corresponding two of the plurality of sub-aligning steps being determined so as to be greater than a first given light amount having been employed in a first one of the corresponding two of the plurality of sub-aligning steps, which first one of the corresponding two of the plurality of sub-aligning steps is carried out prior to the determining steps, whereas which second one of the corresponding two of the plurality of the sub-aligning steps is carried out after the determining step, in the determining step, the second given light amount to be employed in the second one of the corresponding two of the plurality of sub-aligning steps being determined based on a measured result having been obtained in the first one of the corresponding two of the plurality of sub-aligning steps, so that no coating of the optical fiber is damaged during the second one of the corresponding two of the plurality of sub-aligning steps.

The aligning method includes the determining step between each two of the plurality of sub-aligning steps, in which determining step the second given light amount to be employed in the second one of corresponding two of the plurality of sub-aligning steps is determined so as to be greater than the first given light amount having been employed in the first one of the corresponding two of the plurality of sub-aligning steps. According to the determining step, the second given light amount is determined based on the measured result having been obtained in the first one of the corresponding two of the plurality of sub-aligning steps, so that no coating, such as metalization part, of the optical fiber is damaged during the second one of the corresponding two of the plurality of sub-aligning steps.

The measured result having been obtained in the first one of the corresponding two of the plurality of sub-aligning steps indicates a relationship between (i) the relative location of the optical fiber and the semiconductor laser and (ii) an amount of light emitted from the semiconductor laser and coupled to the optical fiber (fiber emitting light), which relationship has been obtained when the semiconductor laser has emitted the multimode laser having the given light amount. It follows that it is possible to estimate, based on the measured result, a relationship between (i) the relative location of the optical fiber and the semiconductor laser and (ii) an amount of light emitted from the semiconductor laser and not coupled to the optical fiber (leaked light). This makes it possible to suitably determine an emission amount of the semiconductor laser to be employed in the second one of the corresponding two of the plurality of sub-aligning steps so that no coating, such as the metalization part, of the optical fiber will be damaged during the second one of the corresponding two of the plurality of sub-aligning steps.

This makes the aligning method of the present invention advantageous over the invention of the patent literature 1 in which the emission amount of the semiconductor laser is increased within the predetermined range. Specifically, according to the aligning method of the present invention, it is possible to vary an amount of increase in the emission amount of the semiconductor laser, depending on a situation. It is therefore possible in a second one of each two of the plurality of sub-aligning steps to prevent an amount of leaked light from being increased due to (i) an increase in emission amount of the semiconductor laser and (ii) a resulting change in mode distribution. This makes it possible to suitably prevent the metalization part or the like of the optical fiber from being damaged.

Further, according to the aligning method of the present invention, it is preferable that, in the determining step, the second given light amount (P₁) to be employed in the second one of the corresponding two of the plurality of sub-aligning steps is determined in accordance with that minimum light amount (P₀″) of the fiber emitting light which has been obtained, in the first one of the corresponding two of the plurality of sub-aligning steps, around an optimum location found by the measured result having been obtained in the first one of the corresponding two of the plurality of sub-aligning steps.

In a second one of the plurality of the sub-aligning steps, the optical fiber is moved, with respect to the semiconductor laser, from a starting point which is a center of a range over which the scanning has been carried out in a previous one of the sub-aligning steps. Thus, in a case where it is possible to predict an amount of leaked light which will be obtained around the center in the range, it is possible to determine an appropriate emission amount of the semiconductor laser to be employed in the second one of the plurality of sub-aligning steps. This is also true for each of third and subsequent ones of the plurality of sub-aligning steps. By using a minimum amount of the fiber emitting light obtained near a center of a range over which the scanning has been carried out in a previous one of the plurality of sub-aligning steps, it is possible to predict a maximum amount of leaked light (i.e., a maximum difference between an emission amount of the semiconductor laser and a light amount of the fiber emitting light) to be caused in a subsequent one of the plurality of sub-aligning steps. Thus, according to the aligning method of the present invention, the emission amount of the semiconductor laser can be set to be such a value so that no metalization part or the like of the optical fiber is damaged by the leaked light. This allows an appropriate increase range of an emission amount of the semiconductor laser to be set for each of the second and subsequent ones of the plurality of sub-aligning steps. As such, it is possible to more suitably avoid a situation that the metalization part or the like of the optical fiber is damaged during the second and subsequent ones of the plurality of sub-aligning steps each of which is carried out while causing the semiconductor laser to emit light having corresponding increased light amount.

Further, the aligning method of the present invention is arranged so that: in the determining step, the second given light amount (P₁) is determined so that

$${P}_{1} < \frac{{P}_{th} - α}{{P}_{0} - {P}_{0}^{″}} {P}_{0} \qquad inequality ( 1 )$$

is satisfied, where Pₜₕ is a predetermined threshold, and α is an excess loss indicating an increase in amount of light which is not coupled to the optical fiber, the increase being caused by an increase in a spreading angle of the multimode laser light, the increase in the spreading angle of the multimode laser light being caused by an increase in an emission amount of the semiconductor laser from a corresponding given light amount (P₀) to the second given light amount P₁, where the corresponding given light amount (P₀) is the first given light amount having employed in the first one of the corresponding two of the plurality of sub-aligning steps.

In the determining step, by setting P₁ so that the inequality (1) is satisfied, it is possible to cause a maximum amount of the leaked light to be less than the predetermined threshold Pₜₕ, where: P₁ is an emission amount of the semiconductor laser in the second one of the corresponding two of the plurality of sub-aligning steps; P₀″ is a minimum amount of the fiber emitting light obtained within a given range from an optimum location found by the measured result having been obtained in the first one of the corresponding two of the plurality of sub-aligning steps; P₀ is an emission amount of the semiconductor laser in the first one of the corresponding two of the plurality of sub-aligning steps; α is an excess loss which is an increase in amount of the leaked light (light not coupled to the optical fiber), the increase being caused by the increase in a spreading angle of the light emitted from the semiconductor laser, the increase in the spreading angle being caused by the increase in emission amount of the semiconductor laser from the corresponding given light amount P₀ to the corresponding given light amount P₁; and Pₜₕ is a predetermined threshold. This makes it possible to set the amount of the leaked light within a predetermined range and thereby to successfully avoid a situation that the metalization part or the like of the optical fiber is damaged.

Further, according to the aligning method of the present invention, it is preferable that, in the determining step, the excess loss α is found based on a relationship between (i) the emission amount of the multimode laser light and (ii) the spreading angle of and a light intensity distribution of the multimode laser light, the (i) and (ii) being measured in advance.

The excess loss α is the increase in amount of the leaked light (light not coupled to the optical fiber), the increase being caused by the increase in the spreading angle of the light emitted from the semiconductor laser, the increase in the spreading angle being caused by the increase in emission amount of the semiconductor laser from the corresponding given light amount P₀ to the corresponding given light amount P₁. In other words, the excess loss α is an amount of light emitted from the semiconductor laser toward an increased portion of the spreading angle. On this account, it is possible to successfully calculate the excess loss α.

Further, according to the aligning method of the present invention, it is possible to arrange the determining step so that, in the determining step, (i) the fiber emitting light emitted by the optical fiber being measured in light amount, while an emission amount of the semiconductor laser is being gradually increased from the first given light amount, (ii) a gradual increase of the emission amount of the semiconductor laser from the first given light amount being suspended, when a difference between the emission amount of the semiconductor laser and a measured amount of the fiber emitting light becomes greater than a predetermined threshold, and (iii) the second given light amount being determined based on that emission amount of the semiconductor laser which is obtained when the gradual increase of the emission amount has been suspended.

According to the aligning method, after the first one of the each two of the plurality of sub-aligning steps is finished, the emission amount of the semiconductor laser is gradually increased while monitoring amount of the leaked light. This makes it possible to determine an approximate upper limit within which it is possible to increase the emitting amount of the semiconductor laser without causing any damage of the metalization part or the like of the optical fiber. As such, ranges within which increases in emission amount of the semiconductor laser are allowed can be set for the respective plurality of sub-aligning steps, based on approximate upper limits thus determined. This makes it possible to more suitably avoid a situation that the metalization part or the like of the optical fiber is damaged during a sub-aligning step which is carried out while causing the semiconductor laser to emit light of increased amount.

Further, according to the aligning method of the present invention, it is preferable that, in each of the plurality of sub-aligning steps, when a difference between the corresponding given light amount and a measured light amount of the fiber emitting light becomes greater than a predetermined threshold, a movement of the optical fiber with respect to the semiconductor laser is carried out in a reverse direction or is suspended.

According to the aligning method, in each sub-aligning step, the optical fiber is moved, with respect to the semiconductor laser, within a range where a difference between the emission amount of the semiconductor laser and the amount of the fiber emitting light is not greater than the predetermined threshold (i.e., a range in which the amount of the leaked light in the optical fiber is note greater than the predetermined threshold). This makes it possible to suitably avoid a case that, while the optical fiber is being moved relatively to the semiconductor laser, the amount of the leaked light in the optical fiber is so increased that the metalization part or the like of the optical fiber is damaged.

Further, according to the aligning method of the present invention, it is preferable that the threshold is set smaller than a given value, the given value being such a value that the coating of the optical fiber will be damaged in a case where the difference between the amount of the light entering the optical fiber and the amount of the light existing from the optical fiber becomes greater than the given value.

According to the aligning method, the predetermined threshold is set to such a value that no coating (metalization part or the like) of the optical fiber will be damaged as long as the amount of the leaked light in the optical fiber is kept equal or smaller than the threshold. This makes it possible to suitably carry out the aligning method of the present invention.

In the aligning method, it is preferable that a corresponding given light amount in a first one of the plurality of sub-aligning steps is set equal or smaller than the predetermined threshold.

According to the aligning method, in the first one of the plurality of sub-aligning steps, the emission amount of the semiconductor laser is not greater than the predetermined threshold. As such, even in a case where all the light emitted from the semiconductor laser ends up as leaked light, no metalization part of the optical fiber will be damaged. It is therefore possible even in the first one of the plurality of sub-aligning steps to suitably prevent the metalization part or the like of the optical fiber from being damaged.

An aligning apparatus of the present invention is an aligning apparatus for adjusting a relative location of an optical fiber having a coating and a semiconductor laser for emitting multimode laser toward the optical fiber, the aligning apparatus, including: an emission amount control section which controls an emission amount of the semiconductor laser; a moving section which causes the optical fiber to move with respect to the semiconductor laser; a light amount detecting section which measures a light amount of fiber emitting light emitted from the optical fiber; and a control section which controls the emission amount control section and the moving section to carry out a plurality of sub-aligning processes and to carry out a determination process between each two of the plurality of sub-aligning processes, in each of which plurality of sub-aligning processes, (a) the control section obtains, via the light amount detecting section, information indicative of the amount of the fiber emitting light emitted from the optical fiber, while causing the emission amount control section to cause the semiconductor laser to emit the multimode laser light having a corresponding given light amount and while causing the moving section to move the optical fiber with respect to the semiconductor laser, and then (b) the control section causes the relative location of the optical fiber and the semiconductor laser to be adjusted so as to be located at an optimum location where the fiber emitting light has a maximum light amount, and in which determination process, the control section determines a second given light amount to be employed in a second one of corresponding two of the plurality of sub-aligning processes, so that the second given light amount is greater than a first given light amount having been employed in a first one of the corresponding two of the plurality of sub-aligning processes, where which first one of the corresponding two of the plurality of sub-aligning processes is carried out prior to the determination process, whereas which second one of the corresponding two of the plurality of sub-aligning processes is carried out after the determination process, the control section determining the second given light amount in accordance with a result having been obtained in the first one of the corresponding two of the plurality of sub-aligning processes, so that no coating of the optical fiber is damaged during the second one of the corresponding two of the plurality of sub-aligning processes.

According to the aligning apparatus, it is possible to bring about an effect identical with that of the aligning method of the present invention.

[Supplementary to Above Description]

The present invention is not limited to the description of the embodiments above, but may be altered by a skilled person within the scope of the claims. An embodiment based on a proper combination of technical means as disclosed in different embodiments is encompassed in the technical scope of the present invention.

### INDUSTRIAL APPLICABILITY

The present invention is usable in a filed of manufacturing of a light module including a semiconductor laser and an optical fiber.

### REFERENCE SIGNS LIST

1. semiconductor laser
2. optical fiber
3. variable current source (emission amount controlling section)
4. electric-powered stage (moving section)
5. photodetector
6. light amount detecting section
7. main controlling section (controlling section)
10. aligning device
71. measuring controlling section
72. adjusting controlling section
73. determining section
76. gradual increase section

1. An aligning method for adjusting a relative location of an optical fiber having a coating and a semiconductor laser for emitting multimode laser light toward the optical fiber,
said aligning method, comprising:
a plurality of sub-aligning steps, in each of which (a) fiber emitting light emitted from the optical fiber is measured in light amount, while causing the semiconductor laser to emit the multimode laser having a corresponding given light amount and while causing the optical fiber to move with respect to the semiconductor laser, and then (b) the relative location of the optical fiber and the semiconductor laser is adjusted so as to be located at an optimum location where the fiber emitting light has a maximum light amount; and
a determining step between each two of the plurality of sub-aligning steps, in which determining step a second given light amount to be employed in a second one of corresponding two of the plurality of sub-aligning steps being determined so as to be greater than a first given light amount having been employed in a first one of the corresponding two of the plurality of sub-aligning steps, which first one of the corresponding two of the plurality of sub-aligning steps is carried out prior to the determining steps, whereas which second one of the corresponding two of the plurality of the sub-aligning steps is carried out after the determining step,
in the determining step, the second given light amount to be employed in the second one of the corresponding two of the plurality of sub-aligning steps being determined based on a measured result having been obtained in the first one of the corresponding two of the plurality of sub-aligning steps, so that no coating of the optical fiber is damaged during the second one of the corresponding two of the plurality of sub-aligning steps.

2. The aligning method as set forth in claim 1, wherein:
in the determining step, the second given light amount (P₁) to be employed in the second one of the corresponding two of the plurality of sub-aligning steps is determined in accordance with that minimum light amount (P₀″) of the fiber emitting light which has been obtained, in the first one of the corresponding two of the plurality of sub-aligning steps, around an optimum location found by the measured result having been obtained in the first one of the corresponding two of the plurality of sub-aligning steps.

3. The aligning method as set forth in claim 2, wherein:
in the determining step, the second given light amount (P₁) is determined so that
$${P}_{1} < \frac{{P}_{th} - α}{{P}_{0} - {P}_{0}^{″}} {P}_{0} \qquad inequality ( 1 )$$
is satisfied, where Pₜₕ is a predetermined threshold, and α is an excess loss indicating an increase in amount of light which is not coupled to the optical fiber, the increase being caused by an increase in a spreading angle of the multimode laser light, the increase in the spreading angle of the multimode laser light being caused by an increase in an emission amount of the semiconductor laser from a corresponding given light amount (P₀) to the second given light amount P₁, where the corresponding given light amount (P₀) is the first given light amount having employed in the first one of the corresponding two of the plurality of sub-aligning steps.

4. The aligning method as set forth in claim 3, wherein:
in the determining step, the excess loss α is found based on a relationship between (i) the emission amount of the multimode laser light and (ii) the spreading angle of and a light intensity distribution of the multimode laser light, the (i) and (ii) being measured in advance.

5. An aligning method for adjusting a relative location of an optical fiber having a coating and a semiconductor laser for emitting multimode laser light toward the optical fiber,
said aligning method, comprising:
a plurality of sub-aligning steps, in each of which (a) fiber emitting light emitted from the optical fiber is measured in light amount, while causing the semiconductor laser to emit the multimode laser light having a corresponding given light amount and while causing the optical fiber to move with respect to the semiconductor laser, and then (b) the relative location of the optical fiber and the semiconductor laser is adjusted so as to be located at an optimum location where the fiber emitting light has a maximum light amount; and
a determining step between each two of the plurality of sub-aligning steps, in which determining step a second given light amount to be employed in a second one of corresponding two of the plurality of sub-aligning steps is determined so as to be greater than a first given light amount having been employed in a first one of the corresponding two of the plurality of sub-aligning steps, which first one of the corresponding two of the plurality of sub-aligning steps is carried out prior to the determining step, whereas which second one of the corresponding two of the plurality of sub-aligning steps is carried out after the determining step,
in the determining step, (i) the fiber emitting light emitted by the optical fiber being measured in light amount, while an emission amount of the semiconductor laser is being gradually increased from the first given light amount, (ii) a gradual increase of the emission amount of the semiconductor laser from the first given light amount being suspended, when a difference between the emission amount of the semiconductor laser and a measured amount of the fiber emitting light becomes greater than a predetermined threshold, and (iii) the second given light amount being determined based on that emission amount of the semiconductor laser which is obtained when the gradual increase of the emission amount has been suspended.

6. The aligning method as set forth in claim 1, wherein:
in each of the plurality of sub-aligning steps, when a difference between the corresponding given light amount and a measured light amount of the fiber emitting light becomes greater than a predetermined threshold, a movement of the optical fiber with respect to the semiconductor laser is carried out in a reverse direction or is suspended.

7. The aligning method as set forth in claim 2, wherein:
in each of the plurality of sub-aligning steps, when a difference between the corresponding given light amount and a measured light amount of the fiber emitting light becomes greater than a predetermined threshold, a movement of the optical fiber with respect to the semiconductor laser is carried out in a reverse direction or is suspended.

8. The aligning method as set forth in claim 3, wherein:
in each of the plurality of sub-aligning steps, when a difference between the corresponding given light amount and a measured light amount of the fiber emitting light becomes greater than a predetermined threshold, a movement of the optical fiber with respect to the semiconductor laser is carried out in a reverse direction or is suspended.

9. The aligning method as set forth in claim 4, wherein:
in each of the plurality of sub-aligning steps, when a difference between the corresponding given light amount and a measured light amount of the fiber emitting light becomes greater than a predetermined threshold, a movement of the optical fiber with respect to the semiconductor laser is carried out in a reverse direction or is suspended.

10. The aligning method as set forth in claim 5, wherein:
in each of the plurality of sub-aligning steps, when a difference between the corresponding given light amount and a measured light amount of the optical emitting fiber becomes greater than a predetermined threshold, a movement of the optical fiber with respect to the semiconductor laser is carried out in a reverse direction or is suspended.

11. An aligning apparatus for adjusting a relative location of an optical fiber having a coating and a semiconductor laser for emitting multimode laser toward the optical fiber,
said aligning apparatus, comprising:
an emission amount control section which controls an emission amount of the semiconductor laser;
a moving section which causes the optical fiber to move with respect to the semiconductor laser;
a light amount detecting section which measures a light amount of fiber emitting light emitted from the optical fiber; and
a control section which controls the emission amount control section and the moving section to carry out a plurality of sub-aligning processes and to carry out a determination process between each two of the plurality of sub-aligning processes,
in each of which plurality of sub-aligning processes, (a) the control section obtains, via the light amount detecting section, information indicative of the amount of the fiber emitting light emitted from the optical fiber, while causing the emission amount control section to cause the semiconductor laser to emit the multimode laser light having a corresponding given light amount and while causing the moving section to move the optical fiber with respect to the semiconductor laser, and then (b) the control section causes the relative location of the optical fiber and the semiconductor laser to be adjusted so as to be located at an optimum location where the fiber emitting light has a maximum light amount, and
in which determination process, the control section determines a second given light amount to be employed in a second one of corresponding two of the plurality of sub-aligning processes, so that the second given light amount is greater than a first given light mount having been employed in a first one of the corresponding two of the plurality of sub-aligning processes, where which first one of the corresponding two of the plurality of sub-aligning processes is carried out prior to the determination process, whereas which second one of the corresponding two of the plurality of sub-aligning processes is carried out after the determination process,
the control section determining the second given light amount in accordance with a result having been obtained in the first one of the corresponding two of the plurality of sub-aligning processes, so that no coating of the optical fiber is damaged during the second one of the corresponding two of the plurality of sub-aligning processes.
